(19) United States
(12) Patent Application Publication
(10) Pub. No.: US 2005/0062273 A1
(43) Pub. Date: Mar. 24, 2005

(54) Inflator

(76) Inventors: Naoki Matsuda, Hyogo (JP); Nobuyuki Katsuda, Hyogo (JP)

Correspondence Address: BIRCH STEWART KOLASCH & BIRCH, PO BOX 747, FALLS CHURCH, VA, 22040-0747, US

(21) Appl. No.: 10/910,275

(22) Filed: Aug. 4, 2004

Related U.S. Application Data
(60) Provisional application No. 60/494,590, filed on Aug. 13, 2003.

(30) Foreign Application Priority Data
Aug. 7, 2003 (JP) 2003-289052

(51) Int. Cl. B60R 21/26

(52) U.S. Cl. 280/737

(57) ABSTRACT

The present invention provides an inflator with high operation reliability. A first rupturable plate 47 is broken by high temperature gas generated from a gas generating agent ignited and burnt by an igniter 43, and the high temperature gas flows into interior spaces 16a, 16b to increase an internal pressure in the interior spaces. As a result, two second rupturable plates 26, 36 are broken by pressurization, so that the pressurized gas is jetted from the gas discharge holes 25, 35.

### CROSS REFERENCE TO RELATED APPLICATIONS

This Nonprovisional application claims priority under 35 U.S.C. § 119(e) on U.S. Provisional Application No. 60/494,590 filed on Aug. 13, 2003 and under 35 U.S.C. § 119(a) on Patent Application No. 2003-289052 filed in Japan on Aug. 7, 2003; the entire contents of which are hereby incorporated by reference.

### BACKGROUND OF THE INVENTION

1. Field of the Invention

The present invention relates to an inflator suitable for an air bag system of an automobile.

2. Description of Related Art

An inflator used in an air bag system mounted on an automobile is required for reliability of operation thereof. Particularly, in case that an inflator is of a type where an air bag is inflated by discharging a pressurized gas charged with high pressure, it becomes important to break a closing means (a rupturable plate) for allowing discharge of the pressurized gas. As amounting method of the rupturable plate, a breaking method thereof or the like, various types thereof have been known according to kinds or structures of inflators.

In US 2003/0062713 A1, an inflator 100 of an elongated shape such as shown in FIG. 1 is disclosed. The inflator 100 has two containers 112, 116 and also has gas discharge ports 124, 128 at both end outer sides. The gas discharge ports 124, 128 are closed by rupturable plates 142.

The inflator is provided at a central portion thereof with a connection chamber 120, two orifices 146, 147 are respectively closed by rupturable plates 144, and the two containers 112, 116 are separated from each other. A main body 164 for fixing an igniter 160 is disposed in the connection chamber 120 from a radially outer side, and an ignition enhancer 168 is charged inside the connection chamber.

A pressure generated by activation of the igniter 160 pressurizes the interior of the connection chamber 120, so that two rupturable plates 144 are broken by the pressure and the orifices 146, 147 are opened. Thereafter, since the interiors of the two containers 112, 116 are pressurized, two rupturable plates 142 are opened and a gas is discharged.

However, there are the following problems in the inflator disclosed in US 2003/0062713 A1:

(i) In the inflator 100, two rupturable plates 144 closing two orifices 146, 147 are broken by increase in pressure generated in the interior of the connection chamber 120, and two rupturable plates 142 are also broken by increase in pressure. Thus, since the rupturable plates are broken two by two by pressurizing over two stages, such a risk may arise that only one of two rupturable plates 144 is broken due to a slight difference in thickness between the two rupturable plates 144 or a difference in tensile strength therebetween, and only one of the rupturable plates closing the gas discharge ports 124, 128 is broken, which causes a single side gas jetting or delayed breaking of the other rupturable plate 142. In such a case, it is considered that the air bag is not developed evenly, a delay of air bag development occurs, resulting that protection of a passenger becomes insufficient, in addition that an inflating speed of the air bag is delayed.

(ii) Since two containers 112, 116 are separated from each other by two rupturable plates 144, they have to be charged with a gas from different charging holes and the charging holes need to be sealed individually after charged, which results in increase of the number of assembling steps.

An object of the present invention is to provide an inflator suitable for an air bag system, which can discharge a pressurized gas from two different gas discharge ports evenly.

### SUMMARY OF THE INVENTION

The present invention provides, as a means for solving the problem, an inflator comprising a cylindrical housing charged with a pressurized gas and an ignition means for discharging high temperature gas inside the cylindrical housing. In accordance with this invention, the cylindrical housing has its interior formed in a single space and has gas discharge ports at both ends, ventilation channels to the gas discharge ports are closed by rupturable plates, the ignition means is mounted on a portion of the cylindrical housing between the end portions, and the ignition means is separated from the interior of the cylindrical housing by a single rupturable plate.

The cylindrical housing preferably has a circular cross section in the width direction, but does not necessarily have to be a perfect circle. Instead, the cylindrical housing may be modified appropriately in accordance with the shape and so on of the space that serves as an attachment portion for the inflator to take an elliptical form or a polygonal form which is close to a perfect circle. However it has to be laterally symmetric with respect to the axial center portion.

The ventilation channel or gas discharge port reaching the gas discharge ports existing in the cylindrical housing exist on both end sides and they are identical in size and length.

The rupturable plates closing the gas discharge ports at the both ends are identical in material, thickness, shape, and area.

As the pressurized gas, an inert gas such as argon, helium or the like, nitrogen gas, or the like is used. The charging pressure of the pressurized gas is in the range of about 10 to 67 MPa.

In the present invention, the interior of the cylindrical housing forms a single space, and thereby, when the single rupturable plate is broken by activation of the ignition means and high temperature gas flows into the interior of the cylindrical housing, the high temperature gas is distributed in the interior evenly. For this reason, since a pressure increase in the whole interior of the cylindrical housing becomes even, the rupturable plates closing the gas discharge ports at the both ends are broken simultaneously, so that the pressurized gas is discharged evenly from the gas discharge ports at the both ends.

In a system of breaking rupturable plates two by two in two stages like the conventional art, it is difficult to break two rupturable plates simultaneously, which may result in that a difference in breaking time occurs between the rupturable plates or that a single gas jetting occurs. In the present invention, however, since the single rupturable plate is securely broken by the ignition means and the two rupturable plates are broken by the pressurizing, a difference in breaking time between the two rupturable plates is reduced.

Further, since the interior of the cylindrical housing is formed in a single space, charging of the pressurized gas is completed by one time charging operation, and sealing work for the gas charging hole after charging is also completed by one time operation.

The present invention provides an inflator in which, in the ignition means, an igniter and a gas generating agent are accommodated in an ignition means accommodating space serving as an ignition means chamber, and the one rupturable plate is attached at a position exactly opposite to the igniter in the ignition means chamber.

If the ignition means has a function to discharge high pressure gas or a pressure wave (an impact wave) in a cylindrical housing interior, a structure thereof is not limited specifically. For example, one in which an igniter (an electric igniter provided with a priming) and a gas generating agent ignited and burnt by activation of the igniter to generate high temperature gas are accommodated in an ignition means accommodating space (whose interior space serves as the ignition means chamber) can be applied as the ignition means.

The shape of the ignition means accommodating space is not limited specifically, and an ignition means housing defining the igniter means accommodating space is integrated with the cylindrical housing by welding or the like.

With such a structure, the igniter can be mounted easily, adjustment of a positional relationship between the igniter and the single rupturable plate is made easy, and breaking ability of the single rupturable plate and a rupturable member closing a gas discharge port is also improved. In this case, either one of a system that the single rupturable plate is broken by high temperature gas or a shock wave occurring after the gas generating agent is ignited and burnt by the igniter and a system that the single rupturable plate is broken by only the igniter may be employed. As the inflator of the present invention, the following two structures can be employed.

(i) In the case of a system of breaking the single rupturable plate by the igniter and the gas generating agent, the gas generating agent is disposed between the igniter and the rupturable plate in a path communicating the igniter with the cylindrical housing interior. In this case, the gas generating agent is accommodated in an ambient pressure atmosphere.

(ii) In the case of a system of breaking the single rupturable plate by the igniter, the gas generating agent is accommodated between the rupturable plate and the cylindrical housing in a path communicating the igniter with the cylindrical housing interior. In this case, the gas generating agent is accommodated in a high pressure atmosphere.

The present invention provides an inflator in which the ignition means accommodating space is mounted to divide the cylindrical housing into two portions, and a cylindrical housing interior forms a single space through a communication hole provided in the ignition means accommodating space.

By mounting the ignition means in this manner, the whole inflator can be made compact. Incidentally, since the ignition means accommodating space divides the cylindrical housing into two portions, it has a wall surface area equal to or more than a widthwise sectional area of the cylindrical housing.

Even in either of the cases (i) and (ii), the communication hole formed in the ignition means accommodating housing has a flow path sectional area in such an extent that pressure loss is not substantially generated to gas flow.

The present invention provides an inflator in which the ignition means is mounted at the axial central portion of the cylindrical housing.

Since the inflator becomes laterally symmetrical, it becomes unnecessary to define a mounting orientation of the inflator at a mounting time thereof, which results in improvement in workability.

The present invention provides an inflator in which each end of the inflator is provided with a single ventilation channel reaching the gas discharge ports, and each channel is closed by a single rupturable plate.

When a diffuser member is provided with a gas discharge port closed by a rupturable plate, the rupturable plate is securely broken so that the gas discharge port is opened to make the pressurized gas discharged.

The present invention provides an inflator in which the center of the ventilation channels reaching the gas discharge ports at the both ends is coincident with the central axis of the cylindrical housing.

Since parts are symmetrical, they can be manufactured easily and it is unnecessary to determine an orientation of the inflator or the parts at a mounting time thereof.

The present invention provides an inflator comprising a cylindrical housing charged with a pressurized gas and having an interior formed in a single space, wherein said cylindrical housing is provided with a gas discharge port closed by a rupturable member that is formed in both ends thereof, with an igniter means accommodating space fluidly communicating with the interior and isolated from the interior by a single rupturable plate before activating the inflator, and with an igniter means provided within said igniter means accommodating space. The igniter means accommodating space in this embodiment of the invention is provided in a portion of said cylindrical between both ends thereof.

The present invention preferably provides an inflator wherein the igniter means accommodating space is formed by an igniter means housing provided such that the igniter means housing divides said cylindrical housing into two chambers, and the two chambers fluidly communicate with each other through a communication hole.

The present invention preferably provides an inflator wherein the both ends of said cylindrical housing is provided with a diffuser member defining the gas discharge port.

The present invention provides an inflator in which the pressurized gas comprises solely helium. Helium is fast such that a theoretical value of the sound velocity is 1010 m/s (23° C.). Therefore, when the rupturable plate is broken by activation of the ignition means, a propagation velocity of an impact is large as compared with another pressurized gas. For this reason, a timing at which the rupturable plate closing the gas discharge port is broken is advanced so that a discharging start of the pressurized gas can be advanced.

The present invention provides an inflator comprising a cylindrical housing charged with a pressurized gas and an ignition means for discharging high temperature gas inside the cylindrical housing, wherein the cylindrical housing has the interior formed in a single space and the gas discharge ports at both ends, and gas flow paths to the respective ventilation channels are closed by rupturable plates, and the ignition means is mounted on a portion of the cylindrical housing between both end portions thereof, and a path communicating the ignition means and interior of the cylindrical housing with each other is closed by a single rupturable plate.

The present invention further provides the inflator, wherein in the ignition means, an igniter and a gas generating agent are accommodated in an ignition means housing serving as an ignition means chamber, and the one rupturable plate is attached at a position exactly opposite to the igniter in the ignition means chamber.

The present invention further provides the inflator, wherein the ignition means housing is mounted to divide the cylindrical housing into two portions, and a cylindrical housing interior forms a single space through a communication hole provided in the ignition means housing.

The present invention further provides the inflator in which the ignition means is mounted at the axial central portion of the cylindrical housing.

The present invention further provides the inflator, wherein each end of the inflator is provided with a single ventilation channel reaching the gas discharge ports, and each channel is closed by a single rupturable plate.

The present invention further provides the inflator, wherein the center of the ventilation channels reaching the gas discharge ports at the both ends is coincident with the central axis of the cylindrical housing.

The present invention further provides the inflator, wherein the pressurized gas consists essentially of helium.

According to the inflator of the present invention, the pressurized gas can be jetted from the gas discharge ports provided at the both ends of the housing simultaneously and reliably. For this reason, when the inflator is applied to an air bag system of an automobile, operation reliability can be enhanced.

### BRIEF DESCRIPTION OF THE DRAWINGS

FIG. 1 is an axial sectional view of an inflator; and

FIG. 2 is an axial sectional view of another embodiment of an inflator.

### DETAILED DESCRIPTION OF THE PRESENT INVENTION

(1) First Embodiment

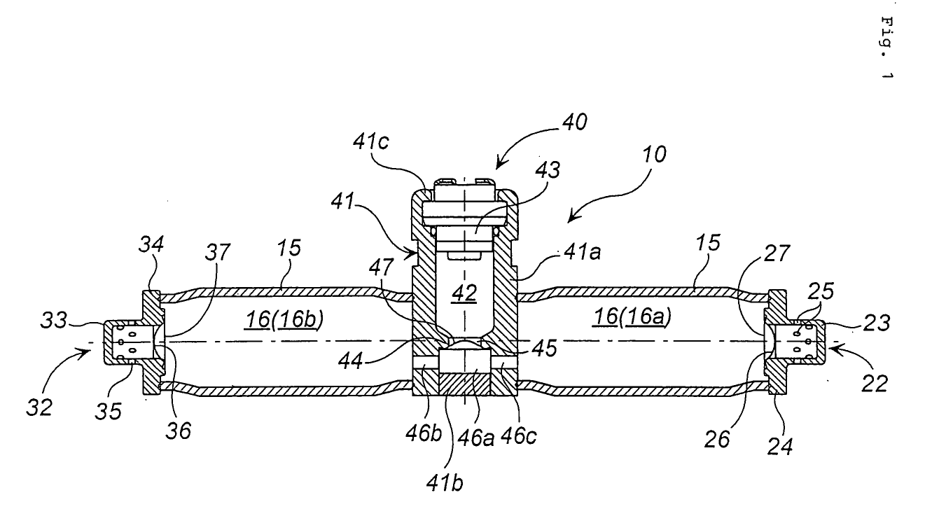

A first embodiment will be explained with reference to FIG. 1. FIG. 1 is an axial sectional view of an inflator.

An inflator 10 is provided with a cylindrical housing 15 charged with a pressurized gas and an ignition means 40 for discharging high temperature gas into an interior space 16 (16a, 16b) of the cylindrical housing 15.

An opening portion at one end of the cylindrical housing 15 is closed by a diffuser cap 22. The diffuser cap 22 comprises a cap portion 23 and a flange portion 24 extending outwardly from an opening portion of the cap portion 23, and a contacting portion between the flange portion 24 and an opening portion of the cylindrical housing 15 is fixed by welding.

The cap portion 23 of the diffuser cap 22 is provided with a predetermined number of gas discharge holes 25. In order to capture fragments of a second rupturable plate 26, a cylindrical filter made of a wire mesh or the like can be disposed, if required, to face the gas discharge holes 25 inside the cap portion 23.

A space inside the cap portion 23 serves as a gas flow path reaching the gas discharge holes 25, and a disk-shaped second rupturable plate 26 (in this case, it is shown in the drawing in a state that it is deformed in a bowl-like shape, receiving pressure due to the pressurized gas) is mounted at a position to close the opening portion 27 of the cap portion 23. In FIG. 1, the amount of a gas discharged from the gas discharge holes 25 is adjusted by the opening portion 27 at the portion where the second rupturable plate 26 is attached.

A peripheral edge portion of the second rupturable plate 26 is fixed to a surface of the flange portion 24 by welding. Since the ventilation channel reaching the gas discharge holes 25 is closed by the second rupturable plate 26, the interior of the cap portion 23 communicating with the outside atmosphere via the gas discharge holes 25 is kept in the ambient pressure.

Another end opening of the cylindrical housing 15 is closed by a diffuser cap 32. The diffuser cap 32 comprises a cap portion 33 and a flange portion 34 extending outwardly from an opening portion of the cap portion 33, and a contacting portion between the flange portion 34 and an opening portion of the cylindrical housing 15 is fixed by welding.

The cap portion 33 of the diffuser cap 32 is provided with a predetermined number of gas discharge ports 35. In order to capture fragments of a second rupturable plate 36, a cylindrical filter made of a wire mesh or the like can be disposed, if required, to face the gas discharge ports 35 inside the cap portion 33.

A space inside the cap portion 33 serves as a gas flow path reaching the gas discharge ports 35, and a disk-shaped second rupturable plate 36 (in this case, it is shown in the drawing in a state that it is deformed in a bowl-like shape, receiving pressure due to the pressurized gas) is mounted at a position to close the opening portion 37 of the cap portion 33. In FIG. 1, the amount of a gas discharged from the gas discharge ports 35 is adjusted by the opening portion 37 at the portion where the second rupturable plate 36 is attached.

A peripheral edge portion of the second rupturable plate 36 is fixed to a surface of the flange portion 34 by welding. Since the ventilation channel reaching the gas discharge ports 35 is closed by the second rupturable plate 36, the interior of the cap portion 33 communicating with the outside atmosphere via the gas discharge ports 35 is kept in the ambient pressure.

The centers of channels (the respective cap portions 23 and 33) reaching the respective gas discharge ports at both end sides are coincident with the center axis of the cylindrical housing 15, and the two channels are identical in size and length. Since the parts are made symmetrical by employing such a constitution, manufacturing is made easy and it is unnecessary to determine an orientation of the inflator at the time of installation.

The second rupturable plates 26, 36 closing the two channels are identical in material, thickness, shape, area and strength.

In the ignition means 40, an igniter 43 and a gas generating agent (not shown) are accommodated in an ignition means housing 41 (whose interior serves as an ignition means accommodating space 42), and it is mounted such that the ignition means housing 41 divides the interior space 16 of the cylindrical housing 15 into two portions.

The ignition means housing 41 comprises a main body 41a and a lid portion 41b, and after the first rupturable plate 47 is fixed to a step portion 44 of the main body 41a by welding, the lid portion 41b is fixed to the main body 41a by mounting welding in an assembling step.

The ignition means housing 41 and the cylindrical housing 15 are welded and fixed to each other at a contacting portion therebetween. After the igniter 43 is fitted into the ignition means housing 41 from an opening portion, it is fixed to the ignition means accommodating housing by crimping a peripheral edge portion 41c thereof.

By mounting the ignition means 40 in this manner, the size of the whole inflator 10 can be made compact as compared with a case that the ignition means is mounted on an outer peripheral face of the cylindrical housing 15. Further, since the inflator 10 becomes laterally symmetrical, it is made unnecessary to define a mounting orientation of the inflator 10 at a mounting time thereof, which results in improvement in workability.

The ignition means housing 41 is provided with second communication paths 46a, 46b, 46c extending in the axial direction of the inflator 10. The interior spaces 16a, 16b divided equally are in communication with each other to form a single space by the second communication paths 46a, 46b, 46c. The second communication path 46a and the second communication paths 46b, 46c are different in diameter, but they all may have the same diameter. However, the second communication paths 46a, 46b, 46c have such flow path section areas that pressure loss is not substantially caused for a gas passing through these paths.

The ignition means accommodating space 42 communicates with the second communication path 46a via a first communication path 45 extending in the radial direction of the inflator 10.

The first communication path 45, and the second communication paths 46a, 46b, 46c serves as a path causing the ignition means 40 and the interior space 16 to communicate with each other, and the first communication path 45 is closed by the first rupturable plate 47. The first rupturable plate 47 faces the igniter 43 exactly.

In FIG. 1, the first rupturable plate 47 is broken by the igniter 43 and the gas generating agent, and, since the gas generating agent is accommodated in the ignition means accommodating space 42 positioned between the igniter 43 and the first rupturable plate 47, the gas generating agent is accommodated in an ambient pressure atmosphere.

As described above, the interior space 16 (16a, 16b) of the cylindrical housing 15 is a single space, and it is maintained in an air-tight state by the first rupturable plate 47, two second rupturable plates 26, 36, the diffuser caps 22, 32. Incidentally, the pressurized gas is charged from a clearance between either one of the diffuser caps 22, 32 and the opening portion of the cylindrical housing 15 (a gas charging hole is provided, if required) before the diffuser caps 22, 32 are fixed, and the diffuser caps are then welded and fixed. It is desirable that the pressurized gas is helium alone.

Next, an operation in case that the inflator 10 has been assembled in an air bag system of an automobile will be explained.

In the event of a vehicle collision, the gas generating agent in the ignition means accommodating space 42 is ignited and burnt by activation of the igniter 43, high temperature gas is generated and the first rupturable plate 47 is broken. At this time, since the ignition means accommodating space 42 accommodating the igniter 43 and the gas generating agent, and the fist rupturable plate 47 are arranged on the same line, flame and high temperature gas advances straight to fist rupturable plate 47 so that a breaking force is elevated.

The high temperature gas passes through the first communication path 45, and the second communication paths 46a, 46b, 46c to flow in the interior space 16 (16a, 16b) and spread evenly, thereby increasing an interior pressure. Since the interior spaces 16a, 16b have the same shape and the same volume, a pressure increases evenly and the two second rupturable plates 26, 36 are pressurized evenly, they are broken simultaneously.

Since the one first rupturable plate 47 is securely broken by the igniter 43 and the gas generating agent in this manner, pressure increase inside the interior spaces 16a, 16b becomes even, and pressurizing states acting on the two second rupturable plates 26, 36 become even, so that the second rupturable plates are simultaneously broken.

Thereafter, the pressurized gas is discharged from the gas discharge holes 25, 35 to inflate the air bag. At this time, since equal amounts of gas are jetted from the gas discharge holes 25, 35, the air bag is developed evenly.

Incidentally, helium is fast such that a theoretical value of the sound velocity is 1010 m/s (23° C.). Therefore, in case of the pressurized gas including only helium (but, in some cases, the gas includes a trace amount of another gas as impurities), when the first rupturable plate 47 is broken by activation of the igniter 23, a propagation velocity of impact is larger as compared with another pressurized gas. For this reason, a timing at which the two second rupturable plates 26, 36 blocking the gas discharge holes 25, 35 at the both ends are broken after rupture of the first rupturable plate 47 is advanced, so that a discharging start of the pressurized gas can be advanced.

(2) Second Embodiment

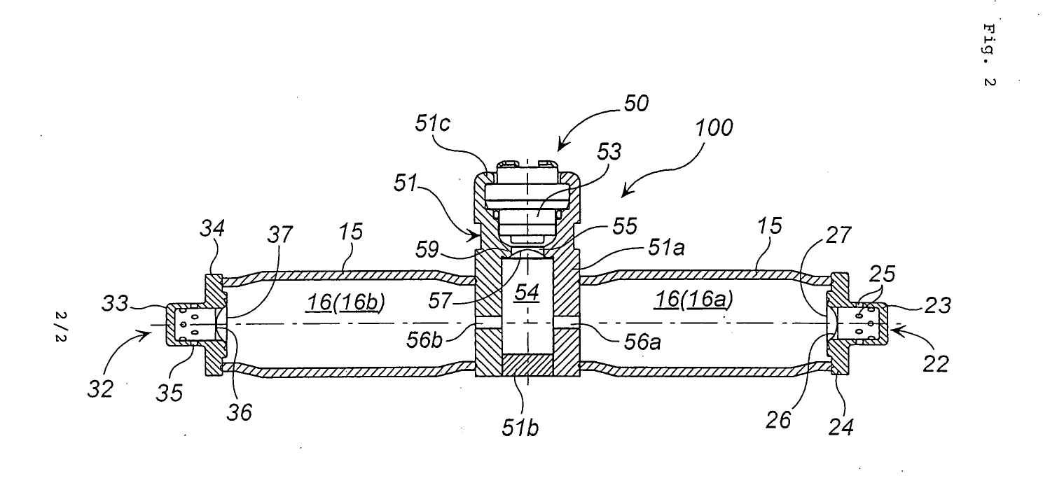

A second embodiment will be explained with reference to FIG. 2. FIG. 2 is an axial sectional view of an inflator 100.

Since an inflator 100 has the same structure as the inflator 10 shown in FIG. 1 except for a portion of an ignition means 50, the same portions are denoted by the same numerals and explanation therefore will be omitted.

In the ignition means 50, an igniter 53 and a gas generating agent (not shown) are accommodated in an ignition means housing 51 (whose interior serves as an ignition means chamber), and it is mounted such that the ignition means housing 51 divides the interior space 16 (16a, 16b) of the cylindrical housing 15 into two portions. The ignition means housing 51 and the cylindrical housing 15 are welded and fixed to each other at a contacting portion therebetween. After the igniter 53 is fitted from an opening portion side of the ignition means housing 51, it is fixed to the ignition means housing by crimping a peripheral edge portion 51c thereof.

The ignition means housing 51 comprises a main body 51a and a lid portion 51b, and after a first rupturable plate 57 is fixed to a step portion 59 of the main body 51a by welding or the like, the lid portion 51b is fixed to the main body 51a by mounting welding in an assembling step.

By mounting the ignition means 50 in this manner, the size of the whole inflator 100 can be made more compact than a case that the ignition means is mounted on an outer peripheral face of the cylindrical housing 15. Further, since the inflator 100 becomes laterally symmetric, it is made unnecessary to define a mounting orientation of the inflator 100 at a mounting time of thereof, which results in improvement in workability.

An ignition means chamber comprises an accommodating space for the igniter 53 and an accommodating space 54 for the gas generating agent, a first communication path 55 is provided between both the spaces, and the first communication path 55 is closed by a first rupturable plate 57. The first rupturable plate 57 faces the igniter 53 exactly.

The ignition means housing 51 is provided with second communication paths 56a, 56b which causes interior spaces 16a, 16b and the accommodating space 54 for the gas generating agent to communicate with each other, and the interior spaces 16a, 16b form a single space by the second communication paths 56a, 56b.

In FIG. 2, the first rupturable plate 57 is broken by only the igniter 53, and, since the gas generating agent is accommodated in the accommodating space 54 for the gas generating agent between the first rupturable plate 57 and the interior space 16, the gas generating agent is accommodated in an ambient pressure atmosphere.

An operation of the inflator 100 is different from that of the inflator 10 in only a breaking system for the first rupturing plate 47 and the former is the same as the latter in the remaining matters. Further, regarding a mechanism for adjusting discharging amounts of gas from the diffuser caps 22, 32, and the flow path sectional areas of the second communication paths 56a, 56b, the inflator 100 is the same as the inflator 10.

1. An inflator comprising a cylindrical housing charged with a pressurized gas and an ignition means for discharging high temperature gas inside the cylindrical housing, wherein
the cylindrical housing has the interior formed in a single space and the gas discharge ports at both ends;
gas flow paths to respective ventilation channels are closed by rupturable plates;
the ignition means is mounted on a portion of the cylindrical housing between the end portions; and
the ignition means is separated from the interior of the cylindrical housing by a single rupturable plate.

2. The inflator according to claim 1, wherein in the ignition means, an igniter and a gas generating agent are accommodated in an ignition means housing serving as an ignition means chamber, and the rupturable plate is attached at a position exactly opposite the igniter in the ignition means chamber.

3. The inflator according to claim 2, wherein the ignition means accommodating space is mounted to divide the cylindrical housing into two portions, and a cylindrical housing interior forms a single space through a communication hole provided in the ignition means housing.

4. The inflator according to claim 1 or 2, in which the ignition means is mounted at the axial central portion of the cylindrical housing.

5. The inflator according to claim 1 or 2, wherein each end of the inflator is provided with a single ventilation channel reaching the gas discharge ports, and each channel is closed by a single rupturable plate.

6. The inflator according to claim 1 or 2, wherein the center of the ventilation channels reaching the gas discharge ports at both ends is coincident with the central axis of the cylindrical housing.

7. An inflator comprising:
a cylindrical housing charged with a pressurized gas and having an interior formed in a single space;
said cylindrical housing being provided with a gas discharge port, closed by a rupturable member, that is formed in both ends thereof;
an igniter means accommodating space fluidly communicating with the interior and isolated from the interior by a single rupturable plate before activating the inflator;
an igniter means provided within said igniter means accommodating space; and
said igniter means accommodating space being provided in a portion of said cylindrical housing between both ends thereof.

8. The inflator according to claim 7, wherein the igniter means accommodating space is formed by an igniter means housing provided such that the igniter means housing divides said cylindrical housing into two chambers, and the two chambers fluidly communicate with each other through a communication hole.

9. The inflator according to claim 8, wherein each end of said cylindrical housing is provided with a diffuser member defining the gas discharge port.

10. The inflator according to claim 1 or 7, wherein the pressurized gas comprises solely helium.
